(19) United States
(12) Patent Application Publication
(10) Pub. No.: US 2025/0168667 A1
(43) Pub. Date: May 22, 2025

(54) SYSTEM AND METHOD FOR MODELING WIRELESS COMMUNICATION ENVIRONMENT FOR NEW RADIO-UNLICENSED SIGNALS

(71) Applicant: Keysight Technologies, Inc., Santa Rosa, CA (US)

(72) Inventors: Huaizhi Yang, Beijing (CN); Bao-Feng Jia, Beijing (CN); Yun-Feng Zhang, Beijing (CN); Jin-Ming Zhao, Beijing (CN)

(21) Appl. No.: 18/924,809

(22) Filed: Oct. 23, 2024

(30) Foreign Application Priority Data
Nov. 20, 2023 (CN) 202311554113.1

(51) Int. Cl. H04W 24/06; H04W 84/12

(52) U.S. Cl. CPC H04W 24/06; H04W 84/12

(57) ABSTRACT

A system and method are provided for modeling a wireless communication environment between UE and an AP within a test space. The method includes receiving a data transmissions at the UE from the AP; determining that at least a portion of the data transmissions is associated with NR-U data; importing and filtering an NR-U UE log to provide filtered NR-U data; generating a power profile for the wireless communication environment using sampled power level measurements from the filtered NR-U data in the NR-U UE log; creating a digital twin map of the test space based on practical geometric configurations of the test space; generating a Doppler profile for the UE using the digital twin map; generating a power delay profile (PDP) profile for the UE using the digital twin map; and building an emulation model for the UE based on the power profile, the Doppler profile and the PDP profile.

### PRIORITY

This application claims priority under 35 U.S.C. § 119 to Chinese Patent Application No. 202311554113.1, filed on Nov. 20, 2023, which is hereby specifically incorporated by reference in its entirety.

### BACKGROUND

Conventional modeling tools are available for converting licensed, fifth generation (5G) new radio (NR) field logs to corresponding channel models, which enable various types of technical testing and analysis of NR wireless communication environments, such as cellular networks. Using such modeling tools, an entire NR field log may be imported, and with some manual filtering, the channel model may be built automatically from the NR field log, enabling emulation of the wireless communication environment. Such emulation provides a platform for product engineers and developers to conduct the testing and analysis of the wireless communication environment under various conditions without having to transmit and receive actual radio frequency (RF) signals under actual conditions.

Some wireless communication environments involve unlicensed new radio (NR-U) frequency bands, including Wifi and other wireless local area networks (WLAN), for example. However, there are no existing field logs and corresponding modeling tools for testing and analyzing such NR-U wireless communication environments, as in licensed NR wireless communication environments. For example, power profiles, Doppler profiles, and power delay profile (PDP) profiles are absent from conventional NR-U field capture systems, which are key channel model parameters for multiple-input and multiple-output (MIMO) correlations.

Therefore, NR-U wireless communication environments are typically “drive tested,” where actual RF signals are transmitted using actual user equipment (UE) and wireless access points (APs), which is time consuming and expensive. It is therefore desirable to be able to model NR-U communications in a manner similar to that of licensed NR communications in an effort to expand throughput where unlicensed coverage is available, alone or using both licensed and unlicensed NR. Thereby enabling product engineers and developers to similarly emulate the NR-U wireless communication environments for conducting similar types of testing and analysis under simulated conditions using without having to transmit and receive actual RF signals under actual conditions.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a simplified block diagram illustrating a system for modeling a wireless communication environment between UE and an AP within a test space, according to a representative embodiment.

FIG. 2 is a flow diagram illustrating a method of modeling a wireless communication environment between UE and an AP within a test space, according to a representative embodiment.

FIG. 3 is a flow diagram illustrating a method of generating power profile for the wireless communication environment, according to a representative embodiment.

FIG. 4 is a flow diagram illustrating a method of creating a digital twin map of the test space, according to a representative embodiment.

FIG. 5A is a diagram of a moving route of a UE through the test space relative to an AP, according to a representative embodiment.

FIG. 5B is a diagram of a digital twin map of the test space derived from the moving route, according to a representative embodiment.

FIG. 6 is a flow diagram illustrating a method of generating Doppler profile of a UE using the digital twin map, according to a representative embodiment.

FIG. 7 is a flow diagram illustrating a method of generating PDP profile of a UE using the digital twin map, according to a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. Additionally, the terms “comprises,” and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

According to a representative embodiment, a method is provided for modeling a wireless communication environment between user equipment (UE) and an access point (AP) within a test space. The method includes receiving a data transmission at the UE from the AP; determining that at least a portion of the data transmission is associated with new radio-unlicensed (NR-U) signals; importing and filtering an NR-U UE log to provide filtered NR-U data, where the NR-U UE log has been previously populated by a field capture tool; generating a power profile for the wireless environment using sampled power level measurements from the filtered NR-U data in the NR-U UE log; creating a digital twin map of the test space based on practical geometric configurations of the test space, where the digital twin map shows relative positions of the AP and multiple waypoints corresponding to multiple positions of the UE moving in a route through the test space; generating a Doppler profile for the UE using the digital twin map, where the Doppler profile is dependent on direction of movement of the UE relative to the AP when moving in the route through the test space; generating a power delay profile (PDP) profile for the UE using the digital twin map; and building an emulation model for the UE based on the power profile, the Doppler profile and the PDP profile.

According to another representative embodiment, a non-transitory computer readable medium stores instructions for modeling a wireless communication environment between UE and an AP within a test space. When executed by at least one processing unit, the instructions cause the at least one processing unit to obtain data transmissions received at the UE from the AP, where at least a portion of the data transmissions is associated with NR-U signals; import and filter an NR-U UE log to provide filtered NR-U data, where the NR-U UE log has been previously populated by a field capture tool; generate a power profile for the wireless communication environment using sampled power level measurements from the filtered NR-U data in the NR-U UE log; create a digital twin map of the test space based on practical geometric configurations of the test space, where the digital twin map shows relative positions of the AP and multiple waypoints corresponding to multiple positions of the UE moving in a route through the test space; generate a Doppler profile for the UE using the digital twin map, where the Doppler profile is dependent on direction of movement of the UE relative to the AP when moving in the route through the test space; generate a PDP profile for the UE using the digital twin map; and build an emulation model for the UE based on the power profile, the Doppler profile and the PDP profile.

According to another representative embodiment, a system is provided for modeling a wireless communication environment between UE and an AP within a test space. The system includes at least one network interface configured to interface with the AP and an NR-U UE log; at least one processing unit; and a non-transitory memory storing instructions that, when executed by the at least one processing unit, cause the at least one processing unit to obtain data transmissions received at the UE from the AP, where at least a portion of the data transmissions is associated with NR-U signals; import and filter the NR-U UE log to provide filtered NR-U data, where the NR-U UE log has been previously populated by a field capture tool; generate a power profile for the wireless communication environment using sampled power level measurements from the filtered NR-U data in the NR-U UE log; create a digital twin map of the test space based on practical geometric configurations of the test space, where the digital twin map shows relative positions of the AP and multiple waypoints corresponding to multiple positions of the UE moving in a route through the test space; generate a Doppler profile for the UE using the digital twin map, where the Doppler profile is dependent on direction of movement of the UE relative to the AP when moving in the route through the test space; generate a PDP profile for the UE using the digital twin map; and build an emulation model for the UE based on the power profile, the Doppler profile and the PDP profile.

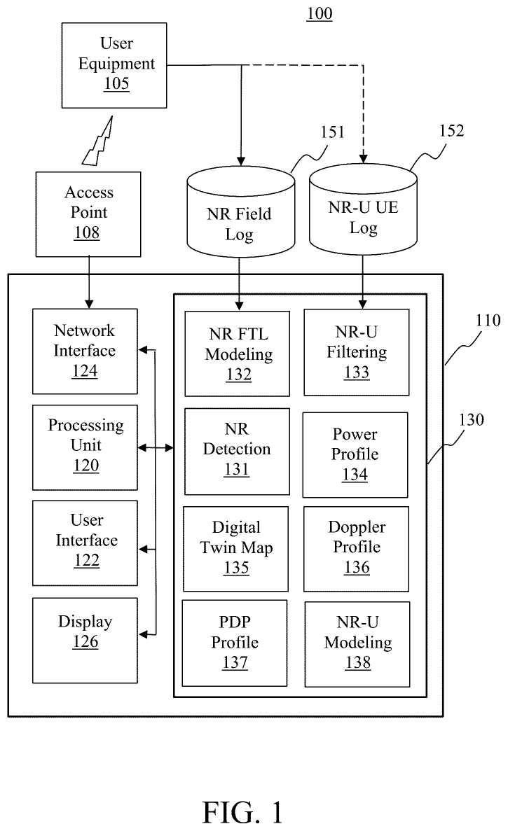

FIG. 1 is a simplified block diagram illustrating a system for modeling a wireless communication environment between UE and a system including an AP within a test space, according to a representative embodiment.

Referring to FIG. 1, system 100 includes a workstation 110 for implementing and/or managing the processes described herein involving testing the wireless communication environment between UE 105 and AP 108, where the AP 108 is part of a wireless communication network, such as wireless local access network (WLAN) (e.g., Wifi network), for example. The workstation 110 includes one or more processors indicated by processing unit 120, one or more memories indicated by memory 130, a user interface 122, a network interface 124, and a display 126. The system 100 further includes a new radio (NR) field log 151 and a new radio-unlicensed (NR-U) UE log 152 that are in communication with the workstation 110. Although not shown in FIG. 1, the NR field log 151 and the NR-U UE log 152 may communicate with the workstation 110 via the network interface 124 or similar network interface using a known compatible interface with the type of network(s) accessing the NR field log 151 and the NR-U UE log 152. The NR field log 151 and the NR-U UE log 152 are also in communication with the UE 105, which is an actual or emulated device under test. The UE 105 may be any type of portable device capable of wireless communication with an AP, such as a cell phone, a tablet, or a laptop computer, for example. The AP 108, which is an actual or emulated network access point configured to communicate wirelessly with the UE 105, may also be in communication with the workstation 110 via the network interface 124 using a known compatible interface with the type of network being accessed by the AP 108. In various embodiments, the AP may be any type of transmitter in a wireless communication network, such as an access point to a WLAN or a base transceiver station (BTS), for example. Also, although FIG. 1 depicts one UE 105 and one AP 108, it is understood that the concepts described herein apply equally to wireless communication environments with more than one UE and/or more than one AP, without departing from the scope of the present teachings.

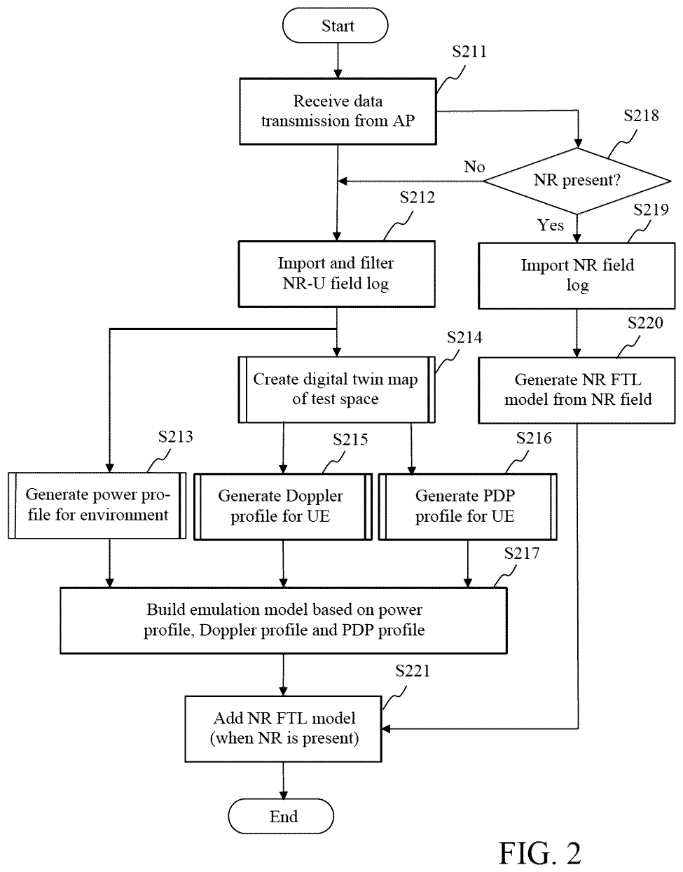

The memory 130 stores instructions executable by the processing unit 120. When executed, the instructions cause the processing unit 120 to implement one or more processes for modeling the wireless communication environment between UE and the AP. Illustrative processes are discussed below with reference to FIGS. 2, 3, 4, 6 and 7. The modeling results may be displayed on the display 126, for example, which may include a graphical user interface (GUI) (not shown) as part of the user interface 122.

The processing unit 120 is representative of one or more processing devices, and may be implemented by field programmable gate arrays (FPGAs), application specific integrated circuits (ASICs), a digital signal processor (DSP), a general purpose computer, a central processing unit, a computer processor, a microprocessor, a microcontroller, a state machine, programmable logic device, or combinations thereof, using any combination of hardware, software, firmware, hard-wired logic circuits, or combinations thereof. Any processing unit or processor herein may include multiple processors, parallel processors, or both. A processor may also refer to a collection of processors within a single computer system or distributed among multiple computer systems, such as in a cloud-based or other multi-site application. Programs have software instructions performed by one or multiple processors that may be within the same computing device or which may be distributed across multiple computing devices.

For purposes of illustration, the memory 130 is shown to include software modules, each of which includes the instructions corresponding to an associated capability of the system 100, discussed below. It is understood that the software modules are not intended to place limitations on the actual arrangement or grouping of software instructions being executed by the processing unit 120 to provide the embodiments described herein.

The memory 130 may include dynamic memory and/or static memory, where such memories may communicate with each other and the processing unit 120 via one or more buses. The memory 130 may be implemented by any number, type and combination of random access memory (RAM) and read-only memory (ROM), for example, and may store various types of information, such as software algorithms, artificial intelligence (AI) machine learning algorithms (models), and computer programs, all of which are executable by the processing unit 120. The various types of ROM and RAM may include any number, type and combination of computer readable storage media, such as a disk drive, flash memory, an electrically programmable read-only memory (EPROM), an electrically erasable and programmable read only memory (EEPROM), registers, a hard disk, a removable disk, tape, compact disk read only memory (CD-ROM), digital versatile disk (DVD), floppy disk, Blu-ray disk, a universal serial bus (USB) drive, or any other form of storage medium known in the art. The memory 130 is a tangible storage medium for storing data and executable software instructions and is non-transitory during the time software instructions are stored therein. The term non-transitory specifically disavows fleeting characteristics such as characteristics of a carrier wave or signal or other forms that exist only transitorily in any place at any time. The memory 130 may store software instructions and/or computer readable code that enable performance of various functions. The memory 130 may be secure and/or encrypted, or unsecure and/or unencrypted.

The processing unit 120 may include or have access to one or more artificial intelligence (AI) engines, which may be implemented as software and that provide artificial intelligence and apply machine learning algorithms described herein. The AI engine(s) may reside in any of various components in the processing unit 120 and the memory 130, as well as in an external server and/or the cloud, for example. When AI engine(s) are implemented in a cloud, such as at a data center, for example, the AI engine(s) may be connected to the processing unit 120 via the internet using one or more wired and/or wireless connection(s).

The user interface 122 receives input from the user to be provided to the processing unit 120 and/or the memory 130, and receives information and data output by the processing unit 120 and/or the memory 130. All or a portion of the user interface 122 may be implemented by a GUI viewable on the display 126, discussed above. The user interface 122 may one or more of a mouse, a keyboard, a trackball, a joystick, a microphone, a touchpad, a touchscreen (on the display 126), voice and/or gesture recognition captured by a microphone or video camera, for example.

The network interface 124 interfaces the workstation 110 with one or more network elements, including the AP 108, the NR field log 151 and the NR-U UE log 152. The network interface 124 may be any known interface that enables the processing unit 120 to access the AP 108 and the NR field log 151 and the NR-U UE log 152 while modeling the wireless communication environment. The network interface 124 may establish and maintain wired or wireless connections. The network interface 124 may be a physical interface, including one or more of ports, disk drives, wireless antennas, wired connectors, receivers, transmitters and firmware/software, for example, when AP 108 and/or the NR field log 151 and the NR-U UE log 152 are embodied as one or more actual network elements. The network interface 124 may be a software interface or an application programming interface (API), for example, when the AP 108 and/or the NR field log 151 and the NR-U UE log 152 are embodied as one or more virtual network elements.

The display 126 may be a monitor such as a computer monitor, a television, a liquid crystal display (LCD), an organic light emitting diode (OLED), a flat panel display, a solid-state display, or a cathode ray tube (CRT) display, or an electronic whiteboard, for example. The display 126 includes a screen for viewing images of network topologies provided by the user, as well as a GUI (optional) to enable the user to interact with the displayed images and features.

In the memory 130, the various functions performed by the processing unit 120 are depicted as separate modules, for the sake of convenience. It is understood, however, that the depiction of separate modules is not intended to be limiting, and that executable instructions in the memory 130 may be arranged and stored in any configuration, without departing from the scope of the present teachings.

Referring to the memory 130, NR detection module 131 is configured to determine whether NR data associated with NR signals is included in the data transmissions from the AP 108 to the UE 105. The presence of the NR data may be determined by post-analysis software, which follows 3GPP standardization, such as Nemo Outdoor 5G NR Drive Test Solution, available from Keysight Technologies, Inc. (“Nemo Outdoor”), for example. In the embodiments herein, it is assumed that NR-U data associated with NR-U signals is present in the data transmissions, so the question is whether the data transmission also includes the NR data. However, in alternative embodiments, the NR detection module 131 may be further configured to detect the presence of NR-U data, as well.

Field-to-lab (FTL) modeling module 132 is configured to generate an FTL model file when it is determined that NR data is present in the data transmissions. The FTL model file models the NR data of the data transmission, based in part on data retrieved from the NR field log 151, according to known FTL modeling toolsets, such as S8811A Device Real Networks Performance Toolset, available from Keysight Technologies, for example. The FTL model file is ultimately included with the emulation model for the UE 105 built based on the NR-U parameters, as discussed below.

With regard to the NR-U data in the data transmission, NR-U filtering module 133 is configured to retrieve and filter NR-U data from the NR-U UE log 152. Generally, the NR-U filtering module 133 provides timestamped data for use by the other memory modules, including power profile module 134, digital twin map module 135, Doppler profile module 136, and PDP profile module 137.

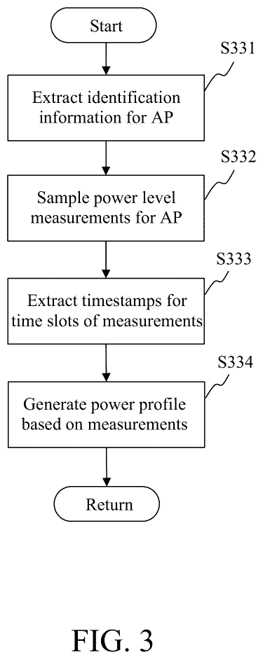

Generally, the power profile module 134 is configured to generate a power profile for the AP 108 in the wireless communication environment. The power profile indicates total power levels of the AP 108 at different times, and is determined based on sampled power level measurements obtained from the filtered NR-U data provided by the NR-U filtering module 133. The process implemented by the power profile module 134 is described below in more detail with reference to FIG. 3.

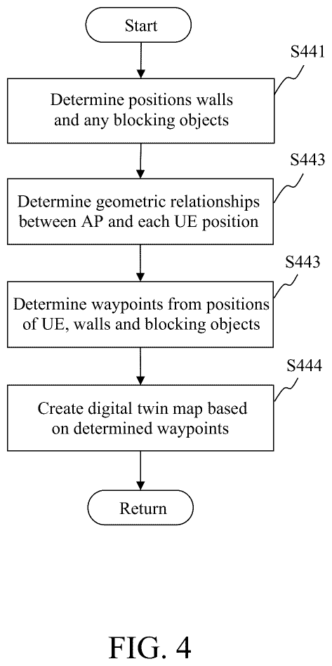

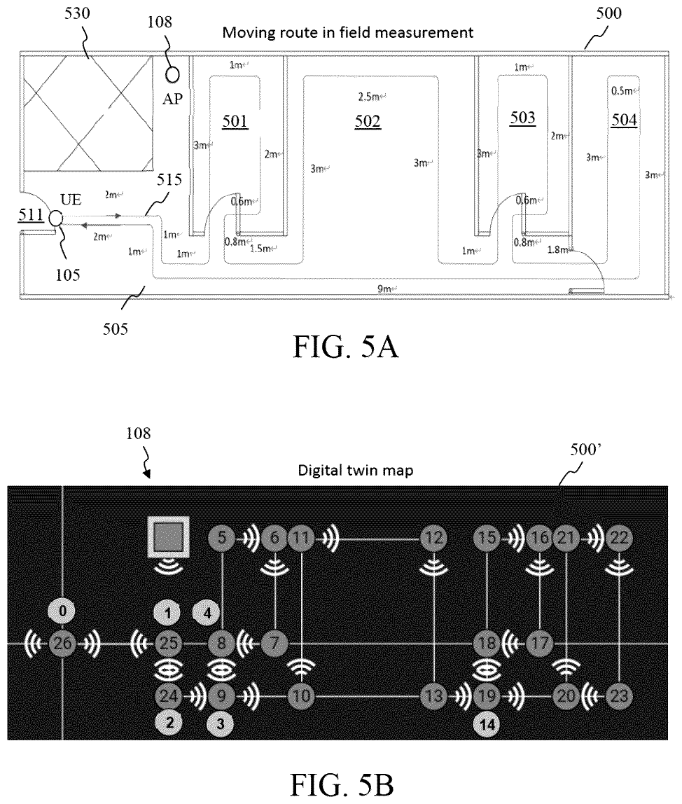

The digital twin map module 135 is configured to create a digital twin map of a test space (simulated or actual) in which the UE 105 and the AP 108 are located, based on practical geometric configurations. That is, the digital twin map module 135 determines a layout of the test space, including positions of walls and any blocking objects, and geometric relationships between the UE 105 and the AP 108 at various positions as the UE 105 moves along a route through the test space. The digital twin map module 135 then generates the digital twin map to include waypoints corresponding to the positions of the UE, and time for each waypoint in the route. The process implemented by the digital twin map module 135 is described below in more detail with reference to FIGS. 4, 5A and 5B.

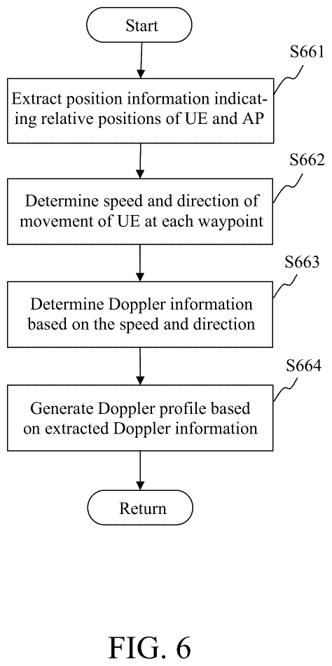

The Doppler profile module 136 is configured to generate a Doppler profile for the UE 105 moving through the test space based in part on position information of the waypoints in the digital twin map. The Doppler profile is determined by positions, speed and direction of the UE 105 at the various waypoints, and frequency response of the NR-U signals is determined from the Doppler profile. The frequency response may include Doppler shift and spread, for example. The process implemented by the Doppler profile module 136 is described below in more detail with reference to FIG. 6.

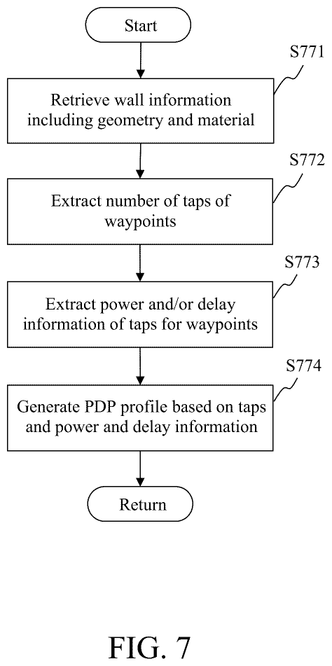

The PDP profile module 137 is configured to generate a PDP profile for the UE 105 moving through the test space based in part on the position information of the waypoints in the digital twin map. The PDP profile is a time-domain measurement of intensity of the NR-U signal as a function of time delay, which is the difference in travel time between multipath arrivals of the NR-U signal through a multipath channel. The process implemented by the PDP profile module 137 is described below in more detail with reference to FIG. 7.

NR-U modeling module 138 is configured to build an emulation model (or emulation file) for the wireless communication environment at the NR-U band 105 based on the power profile, the Doppler profile and the PDP profile. The NR-U modeling module 138 builds the emulation model using the known general modeling toolsets used for generating an FTL model file for NR data present in the data transmissions, as discussed above, such as S8811A Device Real Networks Performance Toolset, available from Keysight Technologies, for example. The difference in using the general modeling toolset is having to obtain key parameters, including the power profile, the Doppler profile, and the PDP profile, as discussed above. The NR-U modeling module 138 may also integrate the FTL model file into the emulation model when it is determined by the NR detection module 331 that NR data is also present in the data transmissions by the AP 108.

FIG. 2 is a flow diagram illustrating a method of modeling a wireless communication environment between UE and an AP within a test space, according to a representative embodiment. The method shown in FIG. 2, as well as the processes shown in FIGS. 3, 4, 6 and 7 corresponding to steps in the method of FIG. 2, as discussed below, may be implemented using a computer, such as workstation 110, for example, discussed above with reference to FIG. 1. The method and process steps may be provided as instructions stored in the memory 130 and executable by the processing unit 120.

Referring to FIG. 2, the method includes receiving data transmissions at the UE (e.g., UE 105) from the AP (e.g., AP 108) in block S211. The UE and the AP are in a test space, such as illustrative test space 500 discussed below with reference to FIG. 5A, for purposes of modeling (emulating) the wireless communication environment. The purpose of modeling the wireless communication environment may include testing and analyzing capabilities of the AP, testing and analyzing capabilities of the UE, and/or test and analyzing the physical layout of the test space, for example.

As stated above, the UE may be any type of portable device capable of wireless and the AP may be any type of transmitter in a wireless communication network. The data transmission from the AP to the UE includes NR-U data from NR-U signals (e.g., from the WLAN), alone or together with NR data from NR signals (e.g., from a cellular network). The presence of NR-U data and NR data in the data transmission may be known beforehand, or may be detected using post-analysis software, such as Nemo Outdoor, for example. When the data transmission includes NR data in addition to the NR-U data, the NR data and the NR-U data are processed separately, as discussed below, where the NR data is modeled according to known NR data modeling techniques and added to the NR-U emulation model.

In block S212, an NR-U UE log (e.g., NR-U UE log 152) is imported by a processing unit (e.g., processing unit 120) from a field capture tool configured to capture measurement data in the field, where the NR-U UE log has been previously populated by the field capture tool. For example, the NR-U UE log may be a Wifi field log, in which case the NR-U UE log may be captured and decoded using Keysight Nemo Outdoor, available from Keysight Technologies, Inc., for example. The imported NR-U UE log may be filtered using a filtering tool, which may be included in the FTL modeling toolset, for example, to remove unuseful data based on the known data format of the NR-U UE log in order to provide filtered NR-U data, including measurement data such as power levels, frequency band information, received signal strength indicator (RSSI), and noise. When global positioning system (GPS) information is available, the NR-U UE log may further include position data indicating location of the UE, for example, which may be used for determining positions, speed and direction of the UE, as discussed below.

Block S213 indicates a process for generating a power profile for the wireless communication environment using sampled power level measurements from the filtered NR-U data in the NR-U UE log. The filtered NR-U data used to determine the power profile may include NR-U identification of the AP and reference signal received power (RSRP) of the AP with corresponding timestamps, for example.

FIG. 3 is a flow diagram illustrating a method of generating the power profile for the wireless communication environment, according to a representative embodiment. Referring to FIG. 3, NR-U identification information identifying the AP is extracted from the filtered NR-U data in the NR-U UE log in block S331. The NR-U identification information may provide the make and model of the AP, and transmission frequency and bandwidth of the data transmission, for example. In block S332, power level measurements (e.g., RSRP measurements) for the AP are sampled from the filtered NR-U data in the NR-U UE log. In block S333, time stamps respectively corresponding to time slots of the sampled power level measurements are extracted from the filtered NR-U data in the NR-U UE log. The power profile is then generated in block S334 based on the time-stamped power level measurements.

In an embodiment, the manner in which the power profile is generated may depend on the number and length of available sample time slots. This is because the power profile may be inaccurate if the power measurements are under-sampled. In this embodiment, a target may be set up for a sample time slot, such as a time slot length of 0.1 second or 1.0 second, for example. When the time slot length is too long (above the target), it means data is being updated too slowly and thus the sampling rate is bad. Therefore, when the time slots are less than the target (i.e., the sampling rate in the NR-U UE log is good), the sampled power level measurements (e.g., RSSI measurements) are imported directly from the filtered NR-U data using linearly-dynamic-interpolation based wave propagation modeling. The power profile may then be generated based on the directly imported sampled power level measurements. However, when the time slots are greater than the target (i.e., the sampling rate in the NR-U UE log is bad), virtual interpolation points are added to the filtered NR-U data in order to generate fast fading effect as normal. The virtual interpolation points may be determined by adding an estimated power level measurement between adjacent time slots by averaging the power level measurements of the time slots. The standard deviation of the power profile is determined using the sampled power level measurements and the virtual interpolation points. Then, the sampled power level measurements and the virtual interpolation points are adjusted by adding the standard deviation to reproduce slow fading effect. In this case, the power profile is generated based on the adjusted sampled power level measurements and the adjusted virtual interpolation points.

Referring again to FIG. 2, block S214 indicates a process for creating a digital twin map of the test space based on practical geometric configurations of the test space. That is, the digital twin map is a virtual representation of the test space that includes walls, physical objects, geometric relationships, and behaviors. For example, the digital twin map shows relative positions of the AP and multiple waypoints corresponding to multiple different positions of the UE moving in a route through the test space. Generally, the digital map may be created in a ray-tracing modeling engine, for example, by importing geometry information using ray-tracing modeling software, which would be apparent to one skilled in the art.

FIG. 4 is a flow diagram illustrating a method of creating a digital twin map of the test space, according to a representative embodiment. Referring to FIG. 4, positions of walls and any blocking objects inside the test space are determined in block S441. The positions of the walls and blocking objects may be determined by a real environment being emulated, for example, or any other layout desired to be tested. In block S442, a geometric relationship between the AP and the UE is determined at each position of the multiple positions of the UE moving in the route through the test space. The geometric relationship may be determined based on position information of the UE. The position information may be provided by GPS, when GPS information is available. Otherwise, when there is no GPS information (e.g., when the UE is inside a walled or shielded space that blocks GPS signals), the position information may be estimated by assumption of the UE moving route, for example, as would be apparent to one skilled in the art. Notably, the course of the route itself and the positions of the UE are dictated at least in part by the positions of the walls and any blocking objects in the test space. In block S443, the multiple waypoints in the route are determined based at least in part on the different positions of the UE in the route and the determined positions of the walls and any blocking objects. For example, a waypoint may be determined at each location where the UE changes direction along the route. In block S444, the digital map is created based on the waypoints in the route.

FIGS. 5A and 5B depict an example of a test space that includes a UE and an AP and a digital twin map generated from the test space. In particular, FIG. 5A is a diagram of a moving route of the UE through the test space relative to an AP, and FIG. 5B is a diagram of a digital twin map of the test space derived from the moving route, according to a representative embodiment. For example, a virtual moving route and corresponding digital twin map may be built using the PROPSIM Geometry Channel Modeling (GCM) tool, available from Keysight Technologies, Inc. Of course, the concepts illustrated by FIGS. 5A and 5B may be applied to test spaces with various different configurations, including one or more UEs and one or more APs, without departing from the scope of the present teachings.

Referring to FIG. 5A, illustrative test space 500 is shown for emulating a wireless communication environment for UE 105 and AP 108, both of which are located within the test space 500. The test space 500 includes a number of walls arranged to define various closed spaces inside the test space, including representative first room 501, second room 502, third room 503, fourth room 504, and corridor 505. For testing purposes, the UE 105 travels a predetermined route 515 through each of the closed spaces in order to emulate the ability of the UE 105 to receive data transmissions throughout the entirety of the test space from the AP 108, while the AP 108 remains in a fixed location. The test space 500 also includes representative shielding chamber 530, which may be one big reflector for the ray-tracing modeling. The shielding chamber 530 may be used for importing objects inside the room for accurate modeling, but is not necessary for the testing.

In the depicted example, as shown by the route 515, the UE 105 begins at entrance 511, travels down the corridor 505, enters and moves around the first room 501, enters and moves around the second room 502, enters and moves around the third room 503, enters and moves around the fourth room 504, and returns to the entrance 511 down the corridor 505. The distance traveled by the UE 105 at each leg of the route 515 is indicated in meters in FIG. 5A. The AP 108 is assumed to be making data transmissions throughout the movement of the UE 105 along the route 515.

Referring to FIG. 5B, an illustrative digital twin map 500′ is shown, which has been derived from the test space 500. The digital twin map 500′ includes waypoints 0 to 26 that correspond to positions of the UE 105 moving along the route 515 in the test space 500. The waypoints 0 to 26 show progression through the digital twin map 500′ in numerical order, and in the depicted example, occur where the route 515 changes direction. Notably, waypoints 0 and 26, waypoints 1, 2, 3, 4 and 14 overlap with waypoints 25, 24, 9, 8 and 20, respectively, where the route 515 crosses the same location twice in the course of navigating the test space 500. The digital twin map 500′ also includes the position of the AP 108, as well as the direction of the antenna of the AP 108, indicated by curved lines. For testing purposes, the UE 105 is assumed to receive data transmissions from the AP 108 at each of the waypoints 0 to 26.

Referring again to FIG. 2, block S215 indicates a process for generating a Doppler profile for the UE using the digital twin map. The Doppler profile is determined based on the positions, speed and direction of the UE relative to the AP at each of the waypoints in the digital twin map when the UE is moving along the route through the test space. The positions of the UE may be determined using the position information of the UE and the AP from the digital twin map, and the speed and direction may be determined using the positions along with corresponding timestamps. The Doppler profile enables determination of frequency response related parameters due to the speed and direction of movement, and includes phase shift and Doppler spread by multiple taps.

FIG. 6 is a flow diagram illustrating a method of generating the Doppler profile of the UE using the digital twin map, according to a representative embodiment. Referring to FIG. 6, in block S661, position information indicating positions of the UE and the AP is extracted for each waypoint of the UE. The position information indicates relative positions of the UE and the AP in the digital twin map for each waypoint, and includes corresponding timestamps indicating the timing of the UE being at each waypoint. As discussed above, the position information may be provided by GPS information, for example, when it is available. In block S662, speed and direction of the UE are determined at each waypoint of the multiple waypoints in the digital twin map based on the position information and the corresponding timestamps. In block S663, Doppler information is determined based on the position, speed, and the direction of movement of the UE relative to the AP at each waypoint, where the Doppler information includes Doppler shift of each tap, which make up Doppler spread. The Doppler information may be determined using GPS position coordinates of the UE, for example, when GPS is available. In block S664, the Doppler profile is generated based on the extracted Doppler information. Generating the Doppler profile may include performing dynamic interpolation between adjacent waypoints of the multiple waypoints.

Referring again to FIG. 2, block S216 indicates a process for generating a PDP profile for the UE using the digital twin map. The UE is assumed to receive data transmissions at each of the waypoints from the AP, either by corresponding discrete transmissions or by continuous transmissions, where at least a portion of the data transmission is assumed to include NR-U data. The PDP profile may be determined using the position information of the UE and the AP from the digital twin map along with corresponding timestamps, as well as geometry and material information about the walls in the test space.

FIG. 7 is a flow diagram illustrating a method of generating the PDP profile of the UE using the digital twin map, according to a representative embodiment. Referring to FIG. 7, in block S771, wall information may be retrieved from real environment or a planned environment to be emulated, where the wall information includes geometry of the walls in the digital twin map and material of the walls within the test space in practice. The geometry of the walls includes the positions of the walls indicated in three-dimensional space by using measurements or other techniques that would be apparent to one skilled in the art. In block S772, a number of taps is extracted from ray-tracing modeling for each waypoint. In block S773, detailed power and/or delay information of each of the taps for each waypoint of the multiple waypoints are extracted. The power and delay information are key factors in determining the PDP profile, where the power information indicates power level for each tap and the delay information indicates delays between multipath arrivals at the taps. The number of taps and the corresponding power and/or delay information of each tap may be extracted by performing ray-tracing using simulation software based on the geometry in the digital twin map, as would be apparent to one skilled in the art. In block S774, the PDP profile is generated based on the number of taps and the detailed power and/or delay information with dynamic interpolation between adjacent waypoints of the waypoints. The dynamic interpolation estimates the power and/or delay information between the waypoints.

Referring again to FIG. 2, in block S217, an NR-U emulation model for the UE is built based at least in part on the three key parameters determined above, that is, the power profile, the Doppler profile and the PDP profile. Now that the power profile, the Doppler profile and the PDP profile have been determined, the NR-U emulation model may be built in substantially the same manner as an NR emulation model, e.g., using a modeling toolset, for which the same parameters are provided by the NR field log. The NR-U emulation model may be loaded into modeling software, such as F8800A/B PROPSIM F64 RF Channel Emulator or F8820A PROPSIM FS16 RF Channel Emulator, available from Keysight Technologies, Inc., for example, to create a final NR-U emulation model file. The NR-U emulation model provides a platform for product engineers and developers to conduct the testing and analysis of the NR-U wireless communication environment under various conditions without having to transmit and receive actual RF signals under actual conditions, thereby improving the breadth and efficiency of the testing and analysis processes from a technical standpoint. That is, the NR-U emulation model may be used to reproduce real environments in the lab.

Meanwhile, in block S218, it may be initially determined whether the data transmission from the AP also includes NR data that is associated with NR signals. When it is determined that the data transmission does not include NR data (block S218: No), the process simply continues to blocks S212-S217, discussed above. However, when the data transmission does include NR data (block S218: Yes), the process proceeds to block S219 where an NR field log (e.g., NR field log 151) is imported. The NR field log includes information not available in the NR-U UE log discussed above, such as the power profile, the Doppler profile and the PDP profile of the NR signals. In block S220, an NR field-to-lab (FTL) model is generated from the NR field log, the generation of which would be apparent to one skilled in the art. In block S221, the NR FTL model is added to the emulation model for the UE. For example, both the NR-U emulation model and the NR FTL model may be loaded into the modeling software, such as F8800A/B PROPSIM F64 RF Channel Emulator or F8820A PROPSIM FS16 RF Channel Emulator, to create a final combined emulation model file, as would be apparent to one skilled in the art. Inclusion of the NR FTL model along with the NR-U emulation model streamlines the testing and analysis of a hybrid NR-U/NR wireless communication environment, further improving the process.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those having ordinary skill in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to an advantage.

Aspects of the present invention may be embodied as an apparatus, method or computer program product. Accordingly, aspects of the present invention may take the form of an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon.

While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

1. A method for modeling a wireless communication environment between user equipment (UE) and an access point (AP) within a test space, the method comprising:
receiving data transmissions at the UE from the AP, wherein at least a portion of the data transmissions is associated with new radio-unlicensed (NR-U) signals;
importing and filtering an NR-U UE log to provide filtered NR-U data, wherein the NR-U UE log has been previously populated by a field capture tool;
generating a power profile for the wireless communication environment using sampled power level measurements from the filtered NR-U data in the NR-U UE log;
creating a digital twin map of the test space based on practical geometric configurations of the test space, wherein the digital twin map shows relative positions of the AP and a plurality of waypoints corresponding to a plurality of positions of the UE moving in a route through the test space;
generating a Doppler profile for the UE using the digital twin map, wherein the Doppler profile is dependent on direction of movement of the UE relative to the AP when moving in the route through the test space;
generating a power delay profile (PDP) profile for the UE using the digital twin map; and
building an emulation model for the UE based on the power profile, the Doppler profile and the PDP profile.

2. The method of claim 1, further comprising:
initially determining whether another portion of the data transmissions includes NR data associated with NR signals; and
when another portion of the data transmissions includes the NR data, importing an NR field log corresponding to the NR data, and generating an NR field-to-lab (FTL) model using the imported NR field log, wherein building the emulation model is further based on the NR FTL model.

3. The method of claim 1, wherein generating the power profile comprises:
extracting identification information for the AP from the filtered NR-U data in the NR-U UE log;
extracting the sampled power level measurements for the AP from the filtered NR-U data in the NR-U UE log;
extracting time stamps respectively corresponding to time slots of the sampled power level measurements from the filtered NR-U data in the NR-U UE log; and
generating the power profile based on the time-stamped power level measurements.

4. The method of claim 3, wherein generating the power profile further comprises:
setting up a target for a sample time slot;
when the time slots are less than the target, importing the sampled power level measurements directly from the filtered NR-U data using linearly-dynamic-interpolation based wave propagation modeling, and generating the power profile based on the directly imported sampled power level measurements; and
when the time slots are greater than target, adding virtual interpolation points to the filtered NR-U data, determining standard deviation of the power profile, adjusting the sampled power level measurements and the virtual interpolation points by adding the standard deviation to reproduce slow fading effect, and generating the power profile based on the adjusted sampled power level measurements and the adjusted virtual interpolation points.

5. The method of claim 1, wherein creating the digital twin map from the filtered NR-U data comprises:
determining positions of walls and any blocking objects inside the test space;
determining a geometric relationship between the UE and the AP at each position of the plurality of positions of the UE moving in the route through the test space; and
determining the plurality of waypoints in the route based at least in part on the positions of the walls and any blocking objects.

6. The method of claim 5, wherein generating the Doppler profile using the digital twin map comprises:
extracting position information indicating positions of the UE and the AP in the digital twin map for each waypoint;
determining speed and a direction of movement of the UE at each waypoint of the plurality of waypoints based on the position information and time;
determining Doppler information based on the speed in the direction of movement of the UE relative to the AP for each waypoint; and
generating the Doppler profile based on the extracted Doppler information with dynamic interpolation between adjacent waypoints of the plurality of waypoints.

7. The method of claim 5, wherein generating the PDP profile using the digital twin map comprises:
retrieving wall information including geometry in the digital twin map and material of the walls within the test space in practice, wherein the geometry includes the positions of the walls; and
extracting a number of taps and detailed power and/or delay information of each of the taps for each waypoint of the plurality of waypoints, by performing a ray-tracing method using simulation software, based on the geometry in the digital twin map; and
generating the PDP profile based on the number of taps and the detailed power and/or delay information with dynamic interpolation between adjacent waypoints of the plurality of waypoints.

8. The method of claim 1, wherein the filtered NR-U data comprises data from a wireless local access network (WLAN).

9. The method of claim 1, wherein the WLAN comprises a Wifi network.

10. A non-transitory computer readable medium storing instructions for modeling a wireless communication environment between user equipment (UE) and an access point (AP) within a test space, that when executed by at least one processing unit, the instructions cause the at least one processing unit to:
obtain data transmissions received at the UE from the AP, wherein at least a portion of the data transmissions is associated with new radio-unlicensed (NR-U) signals;
import and filter an NR-U UE log to provide filtered NR-U data, wherein the NR-U UE log has been previously populated by a field capture tool;
generate a power profile for the wireless communication environment using sampled power level measurements from the filtered NR-U data in the NR-U UE log;
create a digital twin map of the test space based on practical geometric configurations of the test space, wherein the digital twin map shows relative positions of the AP and a plurality of waypoints corresponding to a plurality of positions of the UE moving in a route through the test space;
generate a Doppler profile for the UE using the digital twin map, wherein the Doppler profile is dependent on direction of movement of the UE relative to the AP when moving in the route through the test space;
generate a power delay profile (PDP) profile for the UE using the digital twin map; and
build an emulation model for the UE based on the power profile, the Doppler profile and the PDP profile.

11. The non-transitory computer readable medium of claim 10, wherein the instructions further cause the at least one processing unit to:
initially determine whether another portion of the data transmissions includes NR data associated with NR signals; and
when another portion of the data transmissions includes the NR data, import an NR field log corresponding to the NR data, and generate an NR field-to-lab (FTL) model using the imported NR field log, wherein the emulation model is built further based on the NR FTL model.

12. The non-transitory computer readable medium of claim 10, wherein the instructions cause the at least one processing unit to generate the power profile by:
extracting identification information for the AP from the filtered NR-U data in the NR-U UE log;
extracting the sampled power level measurements for the AP from the filtered NR-U data in the NR-U UE log;
extracting time stamps respectively corresponding to time slots of the sampled power level measurements from the filtered NR-U data in the NR-U UE log; and
generating the power profile based on the time-stamped power level measurements.

13. The non-transitory computer readable medium of claim 12, wherein the instructions further cause the at least one processing unit to generate the power profile by:
setting up a target for a sample time slot;
when the time slots are less than the target, importing the sampled power level measurements directly from the filtered NR-U data using linearly-dynamic-interpolation based wave propagation modeling, and generating the power profile based on the directly imported sampled power level measurements; and
when the time slots are greater than target, adding virtual interpolation points to the filtered NR-U data, determining standard deviation of the power profile, adjusting the sampled power level measurements and the virtual interpolation points by adding the standard deviation to reproduce slow fading effect, and generating the power profile based on the adjusted sampled power level measurements and the adjusted virtual interpolation points.

14. The non-transitory computer readable medium of claim 12, wherein the instructions cause the at least one processing unit to create the digital twin map from the filtered NR-U data by:
determining positions of walls and any blocking objects inside the test space;
determining a geometric relationship between the UE and the AP at each position of the plurality of positions of the UE moving in the route through the test space; and
determining the plurality of waypoints in the route based at least in part on the positions of the walls and any blocking objects.

15. The non-transitory computer readable medium of claim 14, wherein the instructions cause the at least one processing unit to generate the Doppler profile using the digital twin map by:
determining speed and a direction of movement of the UE at each waypoint of the plurality of waypoints based on position information and time;
determining Doppler information based on the speed in the direction of movement of the UE relative to the AP for each waypoint; and
generating the Doppler profile based on the extracted Doppler information with dynamic interpolation between adjacent waypoints of the plurality of waypoints.

16. The non-transitory computer readable medium of claim 14, wherein the instructions cause the at least one processing unit to generate the PDP profile using the digital twin map by:
retrieving wall information including geometry in the digital twin map and material of the walls within the test space in practice, wherein the geometry includes the positions of the walls; and
extracting a number of taps and detailed power and/or delay information of each of the taps for each waypoint of the plurality of waypoints, by performing a ray-tracing method using simulation software, based on the geometry in the digital twin map; and
generating the PDP profile based on the number of taps and the detailed power and/or delay information with dynamic interpolation between adjacent waypoints of the plurality of waypoints.

17. A system for modeling a wireless communication environment between user equipment (UE) and an access point (AP) within a test space, the system comprising:
at least one network interface configured to interface with the AP and a new radio-unlicensed (NR-U) UE log;
at least one processing unit; and
a non-transitory memory storing instructions that, when executed by the at least one processing unit, cause the at least one processing unit to:
obtain data transmissions received at the UE from the AP, wherein at least a portion of the data transmissions is associated with NR-U signals;
import and filter the NR-U UE log to provide filtered NR-U data, wherein the NR-U UE log has been previously populated by a field capture tool;
generate a power profile for the wireless communication environment using sampled power level measurements from the filtered NR-U data in the NR-U UE log;
create a digital twin map of the test space based on practical geometric configurations of the test space, wherein the digital twin map shows relative positions of the AP and a plurality of waypoints corresponding to a plurality of positions of the UE moving in a route through the test space;
generate a Doppler profile for the UE using the digital twin map, wherein the Doppler profile is dependent on direction of movement of the UE relative to the AP when moving in the route through the test space;
generate a power delay profile (PDP) profile for the UE using the digital twin map; and
build an emulation model for the UE based on the power profile, the Doppler profile and the PDP profile.

18. The system of claim 17, wherein the instructions further cause the at least one processing unit to:
initially determine whether another portion of the data transmissions includes NR data associated with NR signals; and
when another portion of the data transmissions includes the NR data, import an NR field log corresponding to the NR data, and generate an NR field-to-lab (FTL) model using the imported NR field log, wherein the emulation model is built further based on the NR FTL model.

19. The system of claim 17, wherein the filtered NR-U data comprises data from a wireless local access network (WLAN).

20. The system of claim 19, wherein the WLAN comprises a Wifi network.
